(19) United States
(12) Patent Application Publication
(10) Pub. No.: US 2026/0124744 A1
(43) Pub. Date: May 7, 2026

(54) METHOD FOR EXECUTING NATURAL LANGUAGE INSTRUCTIONS BY AI AGENT CAPABLE OF PRE-EMPTIVELY REVISING ACTIONS USING ENVIRONMENTAL FEEDBACKS AND AI AGENT USING THE SAME

(71) Applicants: Seoul National University R&DB Foundation, Seoul (KR); UIF (University Industry Foundation), Yonsei University, Seoul (KR)

(72) Inventors: Jonghyun Choi, Seoul (KR); Byeonghwi KIM, Seoul (KR); Cheolhong Min, Incheon (KR); Jinyeon Kim, Seoul (KR)

(21) Appl. No.: 18/988,694

(22) Filed: Dec. 19, 2024

(30) Foreign Application Priority Data
Nov. 5, 2024 (KR) 10 2024 0155713

(51) Int. Cl. B25J 9/16; G06F 40/40; G06T 7/50; G06V 10/70; G06V 10/75; G06V 20/70

(52) U.S. Cl. CPC B25J 9/163; G06F 40/40; G06T 7/50; G06V 10/75; G06V 10/768; G06V 20/70; G06T 2207/20081

(57) ABSTRACT

Disclosed is a method for executing natural language instructions by pre-emptively revising actions using environmental feedbacks. The method includes steps of: (a) in response to receiving natural language instructing data, (i) inputting the natural language instructing data into an LLM and thus generate initial task-relevant contexts corresponding to the natural language instructing data, and then generate an initial action plan; (b) for a j-th initial action included in the initial action plan, (i) instructing a semantic data module to generate semantic data, and (ii) inputting the j-th initial action and the semantic data into an environmental feedback module, to compare actual information and expected information and thus generate feedback information; and (c) (i) inputting the feedback information, a current action plan, and a system prompt into the LLM, to generate one or more revised task-relevant contexts and then generate a revised action plan.

### CROSS REFERENCE OF RELATED APPLICATION

This present application claims the benefit of the earlier filing date of Korean non-provisional patent application No. 10-2024-0155713, filed on Nov. 5, 2024, the entire contents of which being incorporated herein by reference.

### FIELD OF THE DISCLOSURE

The present disclosure relates to a method for executing natural language instructions by an AI agent capable of pre-emptively revising actions using environmental feedbacks and the AI agent using the same.

### BACKGROUND OF THE DISCLOSURE

An AI secretary capable of following language instructions to perform menial tasks such as house chores is of everyone's dream. However, in order for an Artificial Intelligence to be able to achieve the above, the AI should navigate, interact with objects, and perform conversational inference in a visually rich 3D environment. Furthermore, it would be ideal for the AI to be able to navigate its environment, interact with the objects, and perform long-term tasks by following the language instructions based on ego-centric vision.

Meanwhile, there are conventional AIs that can navigate its environment by following the natural language instructions, however, the conventional AIs do not consider environmental factors. Thus, the conventional AIs usually perform actions on wrong target objects or perform unnecessary actions such as actions that have already been performed.

Therefore, an improvement for solving this problem is required.

### SUMMARY OF THE DISCLOSURE

It is an object of the present disclosure to solve all the aforementioned problems.

It is another object of the present invention to provide an AI agent capable of instructing an environmental feedback module to compare actual information and expected information, to thereby generate feedback information and thus generate a revised action plan to be used to execute the natural language instructions.

It is still another object of the present invention to provide the AI agent capable of instructing the environmental feedback module to reflect a location, an appearance, an attribute, and a relationship as environmental factors on the feedback information, to thereby prevent the AI agent from interacting with a wrong target object and performing unnecessary actions.

In order to accomplish objects above, representative structures of the present disclosure are described as follows:

In accordance to one aspect of the present disclosure there is provided a method for executing natural language instructions by an AI agent capable of pre-emptively revising actions using environmental feedbacks, including steps of: (a) in response to receiving one or more natural language instructing data as the natural language instructions, the AI agent (i) inputting the natural language instructing data into an LLM (Large Language Model), to thereby instruct the LLM to perform a learning operation on the natural language instructing data and thus generate one or more initial task-relevant contexts corresponding to the natural language instructing data, and (ii) instructing an initial action planner to generate an initial action plan including a first initial action to an n-th initial action by referring to the initial task-relevant contexts, wherein n is an integer equal to or greater than 1; (b) for a j-th initial action among the first initial action to the n-th initial action, while increasing j from 1 to n, the AI agent (i) instructing a semantic data module to perform a learning operation on at least one image acquired from a current direction of the AI agent, to thereby generate at least one semantic data, and (ii) inputting the j-th initial action and the semantic data into an environmental feedback module, to thereby instruct the environmental feedback module to compare actual information and expected information which were acquired during performing the j-th initial action and thus generate feedback information; and (c) the AI agent (i) inputting (1) the feedback information, (2) a current action plan including the j-th initial action to the n-th initial action, and (3) a system prompt capable of providing guidance for tasks into the LLM, to thereby generate one or more revised task-relevant contexts and (ii) instructing a revision action planner to generate a revised action plan including a first revised action to an m-th revised action by referring to the revised task-relevant contexts, and thus execute the natural language instructions according to the revised action plan.

As one example, at the step of (a), the initial task-relevant context corresponding to the natural language instructing data includes information on a task type, at least one target object, at least one related object, a target object expected location, a target object expected appearance class, a target object expected attribute class, and an expected relationship between the target object and the related object.

As one example, at the step of (b), the AI agent instructs the environmental feedback module to use the at least one of (i) information on (1) a target object detected location, (2) a target object detected appearance class, (3) a target object detected attribute class, and (4) a detected relationship between the target object and the related object, as the actual information, and at least one of (ii) information on (5) the target object expected location, (6) the target object expected appearance class, (7) the target object expected attribute class, and (8) the expected relationship between the target object and the related object, as the expected information.

As one example, at the step of (b), the AI agent instructs the environmental feedback module to perform at least one sub-process of (i) generating first feedback information by comparing (1) the target object expected location that is probabilistically acquired from the LLM module with (2) the target object detected location that is acquired by referring to the semantic data, (ii) generating second feedback information by comparing (1) the target object expected appearance class that is set to be a target object class with (2) (2-1) an (i_0)-th target object detected appearance class that is the target object detected appearance class initially acquired and (2-2) an (i_1)-st target object detected appearance class to an (i_D)-th target object detected appearance class that are the target object detected appearance classes acquired from a first direction to a D-th direction, wherein D is an integer greater than or equal to 1, (iii) generating third feedback information by comparing (1) the target object expected attribute class that is set to be an opposite attribute class of an intended attribute class included in the natural language instructing data with (2) the target object detected attribute class, and (iv) generating fourth feedback information by comparing (1) the expected relationship that is set to be an opposite state of an intended relationship included in the natural language instructing data with (2) the detected relationship.

As one example, the semantic data module (i) generates a depth map corresponding to an entire environment by referring to spatial information of the entire environment from the image, (ii) acquires each object mask corresponding to at least part of all objects included in the entire environment, (iii) back-projects the depth map and said each object mask into a 3D-coordinates to thereby generate a semantic spatial map, and (iv) generates the semantic data by referring to the semantic spatial map.

In accordance with another aspect of the present disclosure, there is provided an AI agent for executing natural language instructions capable of pre-emptively revising actions using environmental feedbacks, including: at least one memory that stores instructions; and at least one processor configured to execute the instructions to perform processes of: (I) in response to receiving one or more natural language instructing data as the natural language instructions, the processor (i) inputting the natural language instructing data into an LLM (Large Language Model), to thereby instruct the LLM to perform a learning operation on the natural language instructing data and thus generate one or more initial task-relevant contexts corresponding to the natural language instructing data, and (ii) instructing an initial action planner to generate an initial action plan including a first initial action to an n-th initial action by referring to the initial task-relevant contexts, wherein n is an integer equal to or greater than 1; (II) for a j-th initial action among the first initial action to the n-th initial action, while increasing j from 1 to n, the processor (i) instructing a semantic data module to perform a learning operation on at least one image acquired from a current direction of the AI agent, to thereby generate at least one semantic data, and (ii) inputting the j-th initial action and the semantic data into an environmental feedback module, to thereby instruct the environmental feedback module to compare actual information and expected information which were acquired during performing the j-th initial action and thus generate feedback information; and (c) the processor (i) inputting (1) the feedback information, (2) a current action plan including the j-th initial action to the n-th initial action, and (3) a system prompt capable of providing guidance for tasks into the LLM, to thereby generate one or more revised task-relevant contexts and (ii) instructing a revision action planner to generate a revised action plan including a first revised action to an m-th revised action by referring to the revised task-relevant contexts, and thus execute the instructions according to the revised action plan.

As one example, at the process of (I), the initial task-relevant context corresponding to the natural language instructing data includes information on a task type, at least one target object, at least one related object, a target object expected location, a target object expected appearance class, a target object expected attribute class, and an expected relationship between the target object and the related object.

As one example, at the process of (II), the processor instructs the environmental feedback module to use the at least one of (i) information on (1) a target object detected location, (2) a target object detected appearance class, (3) a target object detected attribute class, and (4) a detected relationship between the target object and the related object, as the actual information, and at least one of (ii) information on (5) the target object expected location, (6) the target object expected appearance class, (7) the target object expected attribute class, and (8) the expected relationship between the target object and the related object, as the expected information.

As one example, at the process of (II), the processor instructs the environmental feedback module to perform at least one sub-process of (i) generating first feedback information by comparing (1) the target object expected location that is probabilistically acquired from the LLM module with (2) the target object detected location that is acquired by referring to the semantic data, (ii) generating second feedback information by comparing (1) the target object expected appearance class that is set to be a target object class with (2) (2-1) an (i_0)-th target object detected appearance class that is the target object detected appearance class initially acquired and (2-2) an (i_1)-st target object detected appearance class to an (i_D)-th target object detected appearance class that are the target object detected appearance classes acquired from a first direction to a D-th direction, wherein D is an integer greater than or equal to 1, (iii) generating third feedback information by comparing (1) the target object expected attribute class that is set to be an opposite attribute class of an intended attribute class included in the natural language instructing data with (2) the target object detected attribute class, and (iv) generating fourth feedback information by comparing (1) the expected relationship that is set to be an opposite state of an intended relationship included in the natural language instructing data with (2) the detected relationship.

As one example, the semantic data module (i) generates a depth map corresponding to an entire environment by referring to spatial information of the entire environment from the image, (ii) acquires each object mask corresponding to at least part of all objects included in the entire environment, (iii) back-projects the depth map and said each object mask into a 3D-coordinates to thereby generate a semantic spatial map, and (iv) generates the semantic data by referring to the semantic spatial map.

### BRIEF DESCRIPTION OF THE DRAWINGS

The following drawings to be used for explaining example embodiments of the present disclosure are only part of example embodiments of the present disclosure and other drawings can be acquired based on the drawings by those skilled in the art of the present disclosure without inventive work.

FIG. 1 is a drawing schematically illustrating a configuration of an AI agent including an initial action planner, a revision action planner, and an environmental feedback module in accordance with one example embodiment of the present disclosure.

FIG. 2 is a drawing schematically illustrating a flowchart of a method of executing natural language instructions by the AI agent including the initial action planner, the revision action planner, and the environmental feedback module in accordance with one example embodiment of the present disclosure.

FIG. 3 is a drawing schematically illustrating a method of the AI agent generating an initial action plan by extracting task-relevant contexts from natural language instructing data in accordance with one example embodiment of the present disclosure.

FIG. 4 is a drawing schematically illustrating a detailed configuration of the environmental feedback module of the AI agent in accordance with one example embodiment of the present disclosure.

FIG. 5 is a drawing schematically illustrating a method of generating a revised action plan by the revision action planner in accordance with one example embodiment of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to carry out the present invention easily, the example embodiments of the present invention by referring to attached diagrams will be explained in detail as shown below.

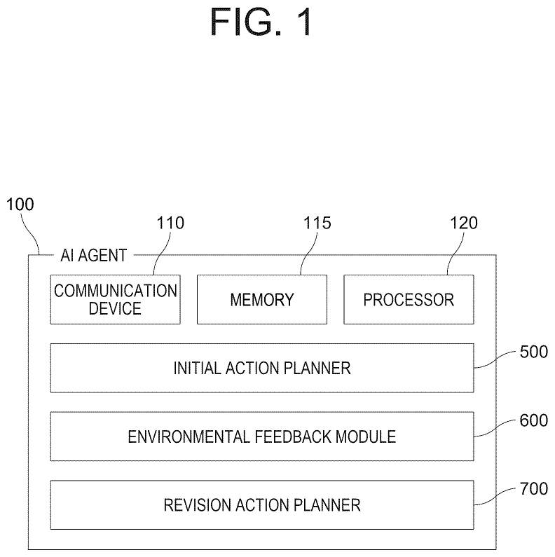

FIG. 1 is a drawing schematically illustrating a configuration of an AI agent including an initial action planner 500, an environmental feedback module 600, and a revision action planner 700 in accordance with one example embodiment of the present disclosure.

By referring to FIG. 1, it can be seen that the AI agent 100 may include the initial action planner 500, the environmental feedback module 600, and the revision action planner 700. Herein, input/output and arithmetic processes of the initial action planner 500, the environmental feedback module 600, and the revision action planner 700 may be performed by a communication part 110 and a processor 120. However, a detailed connection between the communication part 110 and the processor 120 is omitted in FIG. 1. Further, the processor 120 may perform methods of the present disclosure to be explained hereinafter by executing instructions stored in a memory 115. Such description of the AI agent 100 does not exclude a case in which the AI agent includes an integrated processor comprised of a processor, a memory, and a medium.

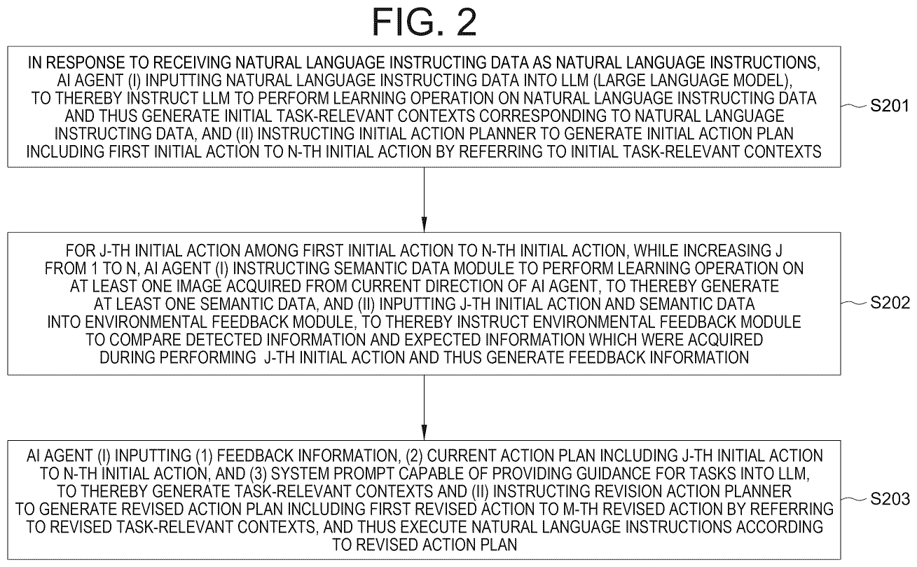

Next, details of how the AI agent 100 executes natural language instructions will be explained by referring to FIG. 2.

FIG. 2 is a drawing schematically illustrating a flowchart of a method of executing the natural language instructions by the AI agent including the initial action planner 500, the environmental feedback module 600, and the revision action planner 700 in accordance with one example embodiment of the present disclosure.

By referring to FIG. 2, in response to receiving one or more natural language instructing data as the instructions, the AI agent 100 may (i) input the natural language instructing data into an LLM (Large Language Model), to thereby instruct the LLM to perform a learning operation on the natural language instructing data and thus generate one or more initial task-relevant contexts corresponding to the natural language instructing data, and (ii) instruct the initial action planner 500 to generate an initial action plan including a first initial action to an n-th initial action (n is an integer equal to or greater than 1) by referring to the initial task-relevant contexts, at a step of S201.

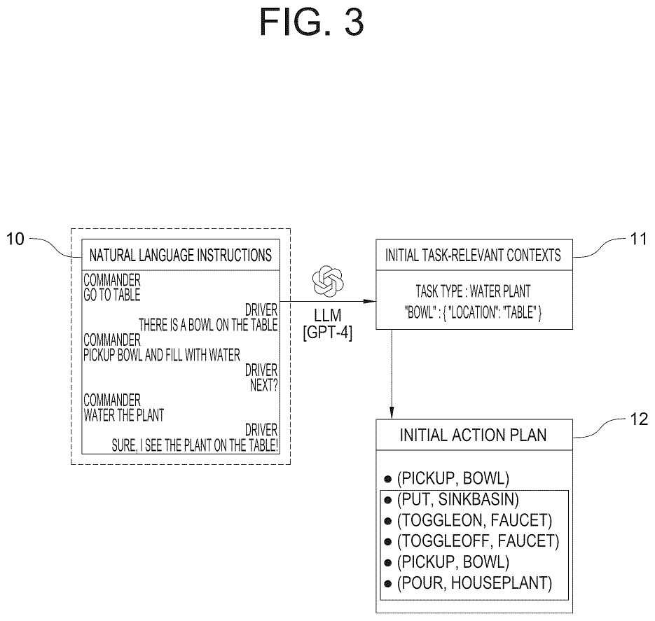

Specifically, by referring to FIG. 3, in response to receiving the natural language instructing data 10, the natural language instructing data 10 may be inputted into the LLM, and then the LLM performs the learning operation on the natural language instructing data 10 to generate the initial task-relevant contexts 11 corresponding to the natural language instructing data 10. Afterwards, the initial action planner 500 generates the initial action plan 12, which includes the first initial action to the n-th initial action, corresponding to the natural language instructing data 10 by referring to the initial task-relevant contexts 11. For reference, the initial action planner 500 may include the LLM or may be separate therefrom.

Herein, the initial task-relevant context 11 corresponding to the natural language instructing data 10 may include information on a task type, at least one target object, at least one related object, a target object expected location, a target object expected appearance class, a target object expected attribute class, and an expected relationship between the target object and the related object, but it is not limited thereto.

For reference, FIG. 3 illustrates an example of the initial task-relevant context 11. Herein, the task type is “Water Plant”, the target object is “Bowl”, and the target object expected location is “Table”, but they are not limited thereto. Also, the first initial action to the n-th initial action are exemplarily illustrated as (Pickup, Bowl), (Put, SinkBasin), (ToggleOn, Faucet), (ToggleOff, Faucet), (Pickup, Bowl), and (Pour, HousePlant), but they are not limited thereto.

By referring back to FIG. 2, after the step of S201, for a j-th initial action among the first initial action to the n-th initial action, while increasing j from 1 to n, the AI agent 100 may (i) instruct a semantic data module to perform a learning operation on at least one image acquired from a current direction of the AI agent 100, to thereby generate at least one semantic data, and (ii) input the j-th initial action and the semantic data into the environmental feedback module 600, to thereby instruct the environmental feedback module 600 to compare actual information and expected information which were acquired during performing the j-th initial action and thus generate feedback information, at a step of S202.

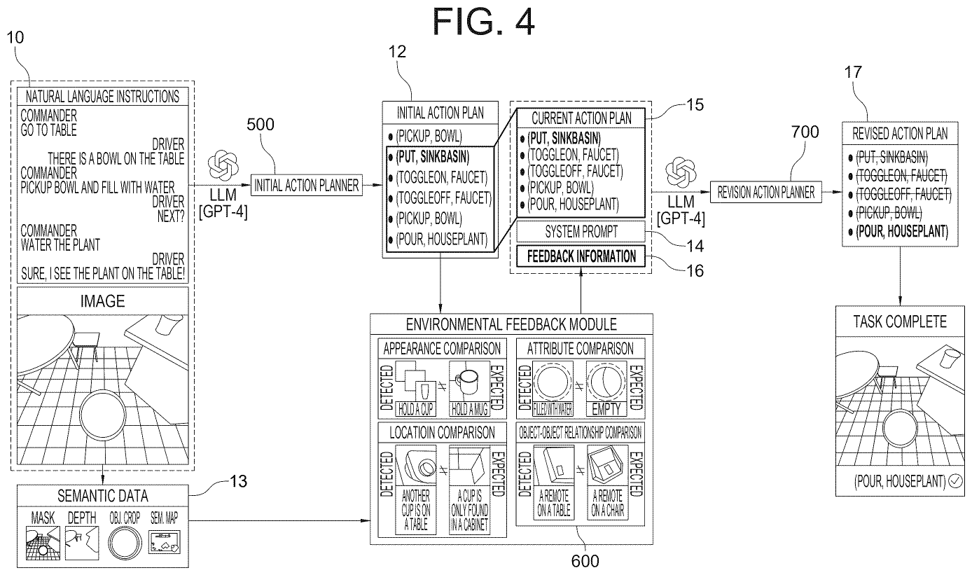

Herein, by referring to FIG. 4, the semantic data module may (i) generate a depth map corresponding to an entire environment by referring to spatial information of the entire environment the image, (ii) acquire each object mask corresponding to at least part of all objects included in the entire environment, (iii) back-project the depth map and said each object mask into a 3D-coordinates to thereby generate a semantic spatial map, and (iv) generate the semantic data 13 by referring to the semantic spatial map.

Afterwards, the AI agent 100 may input the j-th initial action and the semantic data 13 into the environmental feedback module 600, to thereby instruct the environmental feedback module 600 to compare the actual information and the expected information which were acquired during performing the j-th initial action and thus generate the feedback information 16.

Herein, the environmental feedback module 600 may use at least one of (i) information on (1) a target object detected location, (2) a target object detected appearance class, (3) a target object detected attribute class, and (4) a detected relationship between the target object and the related object, as the actual information, and at least one of (ii) information on (5) the target object expected location, (6) the target object expected appearance class, (7) the target object expected attribute class, and (8) the expected relationship between the target object and the related object, as the expected information.

The specifics of how to compare the actual information and the expected information will be explained with reference to FIG. 4 below.

By referring to FIG. 4, the AI agent 100 may instruct the environmental feedback module 600 to generate first feedback information by comparing (1) the target object expected location that is probabilistically acquired from the LLM module with (2) the target object detected location that is acquired by referring to the semantic data.

For example, from an action of washing a cup, the LLM could have probabilistically generated the target object expected location as a cupboard where the target object, the cup, may be found. Therefore, the AI agent 100 may go to the cupboard to get the cup. However, in the actual environment, the target object, i.e., the cup, may be placed on a table instead. In this case, the environmental feedback module 600 may generate the feedback information 16 after comparing the target object detected location, i.e., the table, with the target object expected location, i.e., the cupboard, and finding the target object detected location and the target object expected location to be different from each other. If environmental factors were not taken into account, the AI agent 100 may have gone to the cupboard to get the cup, resulting in erroneous behavior or interaction with a wrong target object.

By referring to FIG. 4 again, the AI agent 100 may instruct the environmental feedback module 600 to generate second feedback information by comparing (1) the target object expected appearance class that is set to be a target object class with (2) (2-1) an (i_0)-th target object detected appearance class that is the target object detected appearance class initially acquired and (2-2) an (i_1)-st target object detected appearance class to an (i_D)-th target object detected appearance class that are the target object detected appearance classes acquired from a first direction to a D-th direction. Herein D is an integer greater than or equal to 1.

For example, from an action of preparing a coffee in a mug, the AI agent 100 may perform an action of searching for the target object, which is a mug. Herein, the target object expected appearance class may be set as the target object class which is “mug”. The AI agent 100 may move to get the target object that looks like “mug” acquired from a (i_0)-th target object detected appearance by referring to the image acquired from the current direction, i.e., a (i_0)-th direction, and then further compare the (i) (i_1)-st target object detected appearance class acquired from the appearance of the target object in the first direction to the (i_D)-th target object detected appearance class acquired from the appearance of the target object in the D-th direction with (ii) the target object expected appearance class, to thereby determine whether the target object is actually a mug. That is, initially, only a part of the target object is viewed, therefore, when the AI agent 100 actually arrives at the target object, it may need to check its appearance from other directions by comparing the target object detected appearance class from different directions with the target object expected appearance class. Therefore, as an example, the feedback information 16 may be generated by comparing the target object detected appearance class (acquired from other directions), which is “cup”, with the target object expected appearance class, which is “mug”, and find them to be different from each other. If the environmental factors were not taken into account, the AI agent 100 may have interacted with the wrong target object by acquiring the wrong target object, i.e., the cup, because initially it was obscured from view.

By referring to FIG. 4 again, the AI agent 100 may generate third feedback information by comparing (1) the target object expected attribute class that is set to be an opposite attribute class of an intended attribute class included in the natural language instructing data with (2) the target object detected attribute class.

For example, from an action of filling a bowl with water, the AI agent 100 may perform an action of filling the target object, which is the bowl, with water. Herein, if the intended attribute class that is included in the natural language instructing data is “the bowl should be filled with water”, then the opposite attribute class of the intended attribute class, which is “the bowl should not be filled with water,” may be set as the target object expected attribute class. Therefore, if the bowl is actually filled with water, the feedback information 16 may be generated after comparing the target object detected attribute class, which is that the bowl is filled water, with the target object expected attribute class, which is that the bowl is not filled with water, and finding them to be different with each other. If the environmental factors were not taken into account, the AI agent 100 may have tried to fill the bowl that was already filled with water, thus performing unnecessary actions.

By referring to FIG. 4 again, the AI agent 100 may generate fourth feedback information by comparing (1) the expected relationship that is set to be an opposite state of an intended relationship included in the natural language instructing data with (2) the detected relationship.

For example, from an action of putting two remote controls on the table, the AI agent 100 may try to get the target objects, which are the two remote controls, to the table, which is the related object. Herein, if the intended relationship between the target object (i.e., remote control) and the related object (i.e., table) included in the natural language instructing data is “the remote control should be on the table”, then the expected relationship may be set as the opposite state of the intended relationship, which may be “the remote control should not be on the table.” Therefore, in case one of the two remote controls is already on the table, for the one remote control that is already on the table, the AI agent 100 may generate the feedback information 16 after comparing the detected relationship, which is that “the remote control is on the table” and the expected relationship, which is that “the remote control is not on the table,” and finding them to be different from each other. And, for the other remote control that is not on the table, the AI agent 100 may generate the feedback information 16 by comparing the detected relationship, which is that “the remote control is not on the table” and the expected relationship, and may find them to be the same. If the environmental factors were not taken into account, the AI agent 100 may have tried to perform an unnecessary action of picking up the one remote control among the two remote controls that is already on the table and placing it back on the table.

As described above, the present invention may generate the feedback information by comparing the actual information with the expected information when they are different from each other but may or may not generate the feedback information if they are the same.

By referring back to FIG. 2, the AI agent 100 may input (1) the feedback information, (2) a current action plan including the j-th initial action to the n-th initial action, and (3) a system prompt capable of providing guidance for tasks into the LLM, to thereby generate one or more revised task-relevant contexts and (ii) instruct the revision action planner 700 to generate a revised action plan including a first revised action to an m-th revised action by referring to the revised task-relevant contexts, and thus execute the natural language instructions according to the revised action plan, at a step of S203. It is to be appreciated that the revision action planner 700 may include the LLM or may be separate therefrom.

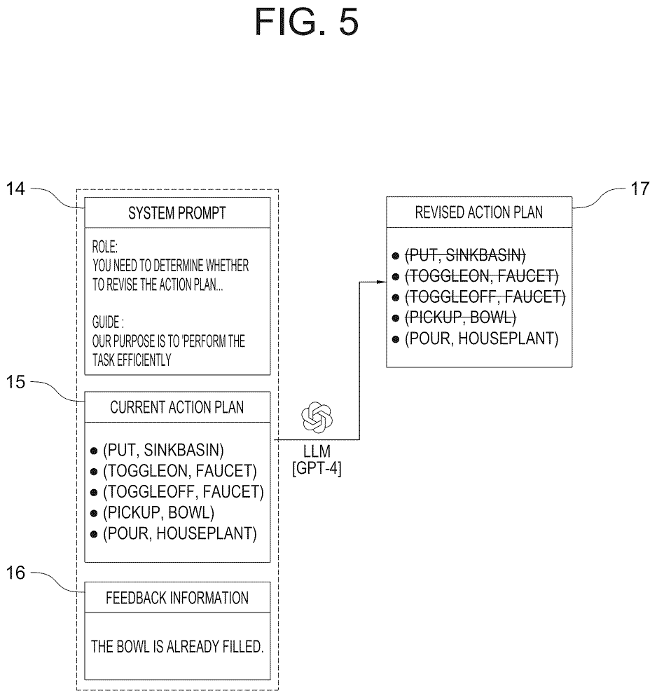

Specifically, FIG. 5 exemplarily illustrates the current action plan 15 (including a task which is currently performed and tasks to be performed subsequently) as (Put, SinkBasin), (ToggleOn, Faucet), (ToggleOff, Faucet), (Pickup, Bowl), (Pour, HousePlant), and exemplarily illustrates the feedback information 16 as “The bowl is already filled”. Then, the AI agent 100 may input the feedback information 16, the current action plan 15, and the system prompt 14 into the LLM to generate the revised task-relevant contexts (not illustrated), and thereby generate the revised action plan 17 as (Pour, HousePlant). That is, in this example, since water is already filled in the bowl, actions related to filling the bowl with water are unnecessary and should be deleted, therefore, only the action of watering the plant is generated as the revised action plan 17.

Accordingly, by considering the environmental factors to generate the feedback information, the chances of performing actions with the wrong target object and/or performing unnecessary actions may be avoided.

The present disclosure has an effect of providing the AI agent capable of instructing the environmental feedback module to compare the actual information and the expected information, to thereby generate the feedback information and thus generate the revised action plan to be used to execute the natural language instructions.

The present disclosure has another effect of providing the AI agent capable of instructing the environmental feedback module to reflect a location, an appearance, an attribute, and a relationship as the environmental factors on the feedback information, to thereby prevent the AI agent from interacting with the wrong target object and performing the unnecessary actions.

The embodiments of the present disclosure as explained above can be implemented in a form of executable program command through a variety of computer means recordable in computer readable media. The computer readable media may include solely or in combination, program commands, data files, and data structures. The program commands recorded to the media may be components specially designed for the present disclosure or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands may include not only a machine language code made by a complier but also a high-level code that can be used by an interpreter etc., which is executed by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for executing natural language instructions by an AI agent Capable of pre-emptively revising actions using environmental feedbacks, comprising steps of:
(a) in response to receiving one or more natural language instructing data as the natural language instructions, the AI agent (i) inputting the natural language instructing data into an LLM (Large Language Model), to thereby instruct the LLM to perform a learning operation on the natural language instructing data and thus generate one or more initial task-relevant contexts corresponding to the natural language instructing data, and (ii) instructing an initial action planner to generate an initial action plan including a first initial action to an n-th initial action by referring to the initial task-relevant contexts, wherein n is an integer equal to or greater than 1;
(b) for a j-th initial action among the first initial action to the n-th initial action, while increasing j from 1 to n, the AI agent (i) instructing a semantic data module to perform a learning operation on at least one image acquired from a current direction of the AI agent, to thereby generate at least one semantic data, and (ii) inputting the j-th initial action and the semantic data into an environmental feedback module, to thereby instruct the environmental feedback module to compare actual information and expected information which were acquired during performing the j-th initial action and thus generate feedback information; and
(c) the AI agent (i) inputting (1) the feedback information, (2) a current action plan including the j-th initial action to the n-th initial action, and (3) a system prompt capable of providing guidance for tasks into the LLM, to thereby generate one or more revised task-relevant contexts and (ii) instructing a revision action planner to generate a revised action plan including a first revised action to an m-th revised action by referring to the revised task-relevant contexts, and thus execute the natural language instructions according to the revised action plan.

2. The method of claim 1, wherein, at the step of (a), the initial task-relevant context corresponding to the natural language instructing data includes information on a task type, at least one target object, at least one related object, a target object expected location, a target object expected appearance class, a target object expected attribute class, and an expected relationship between the target object and the related object.

3. The method of claim 2, wherein, at the step of (b), the AI agent instructs the environmental feedback module to use the at least one of (i) information on (1) a target object detected location, (2) a target object detected appearance class, (3) a target object detected attribute class, and (4) a detected relationship between the target object and the related object, as the actual information, and at least one of (ii) information on (5) the target object expected location, (6) the target object expected appearance class, (7) the target object expected attribute class, and (8) the expected relationship between the target object and the related object, as the expected information.

4. The method of claim 3, wherein, at the step of (b), the AI agent instructs the environmental feedback module to perform at least one sub-process of (i) generating first feedback information by comparing (1) the target object expected location that is probabilistically acquired from the LLM module with (2) the target object detected location that is acquired by referring to the semantic data, (ii) generating second feedback information by comparing (1) the target object expected appearance class that is set to be a target object class with (2) (2-1) an (i_0)-th target object detected appearance class that is the target object detected appearance class initially acquired and (2-2) an (i_1)-st target object detected appearance class to an (i_D)-th target object detected appearance class that are the target object detected appearance classes acquired from a first direction to a D-th direction, wherein D is an integer greater than or equal to 1, (iii) generating third feedback information by comparing (1) the target object expected attribute class that is set to be an opposite attribute class of an intended attribute class included in the natural language instructing data with (2) the target object detected attribute class, and (iv) generating fourth feedback information by comparing (1) the expected relationship that is set to be an opposite state of an intended relationship included in the natural language instructing data with (2) the detected relationship.

5. The method of claim 1, wherein the semantic data module (i) generates a depth map corresponding to an entire environment by referring to spatial information of the entire environment from the image, (ii) acquires each object mask corresponding to at least part of all objects included in the entire environment, (iii) back-projects the depth map and said each object mask into a 3D-coordinates to thereby generate a semantic spatial map, and (iv) generates the semantic data by referring to the semantic spatial map.

6. An AI agent for executing natural language instructions capable of pre-emptively revising actions using environmental feedbacks, comprising:
at least one memory that stores instructions; and
at least one processor configured to execute the instructions to perform processes of: (I) in response to receiving one or more natural language instructing data as the natural language instructions, (i) inputting the natural language instructing data into an LLM (Large Language Model), to thereby instruct the LLM to perform a learning operation on the natural language instructing data and thus generate one or more initial task-relevant contexts corresponding to the natural language instructing data, and (ii) instructing an initial action planner to generate an initial action plan including a first initial action to an n-th initial action by referring to the initial task-relevant contexts, wherein n is an integer equal to or greater than 1; (II) for a j-th initial action among the first initial action to the n-th initial action, while increasing j from 1 to n, (i) instructing a semantic data module to perform a learning operation on at least one image acquired from a current direction of the AI agent, to thereby generate at least one semantic data, and (ii) inputting the j-th initial action and the semantic data into an environmental feedback module, to thereby instruct the environmental feedback module to compare actual information and expected information which were acquired during performing the j-th initial action and thus generate feedback information; and (III) (i) inputting (1) the feedback information, (2) a current action plan including the j-th initial action to the n-th initial action, and (3) a system prompt capable of providing guidance for tasks into the LLM, to thereby generate one or more revised task-relevant contexts and (ii) instructing a revision action planner to generate a revised action plan including a first revised action to an m-th revised action by referring to the revised task-relevant contexts, and thus execute the instructions according to the revised action plan.

7. The AI agent of claim 6, wherein, at the process of (I), the initial task-relevant context corresponding to the natural language instructing data includes information on a task type, at least one target object, at least one related object, a target object expected location, a target object expected appearance class, a target object expected attribute class, and an expected relationship between the target object and the related object.

8. The AI agent of claim 7, wherein, at the process of (II), the processor instructs the environmental feedback module to use the at least one of (i) information on (1) a target object detected location, (2) a target object detected appearance class, (3) a target object detected attribute class, and (4) a detected relationship between the target object and the related object, as the actual information, and at least one of (ii) information on (5) the target object expected location, (6) the target object expected appearance class, (7) the target object expected attribute class, and (8) the expected relationship between the target object and the related object, as the expected information.

9. The method of claim 8, wherein, at the process of (II), the processor instructs the environmental feedback module to perform at least one sub-process of (i) generating first feedback information by comparing (1) the target object expected location that is probabilistically acquired from the LLM module with (2) the target object detected location that is acquired by referring to the semantic data, (ii) generating second feedback information by comparing (1) the target object expected appearance class that is set to be a target object class with (2) (2-1) an (i_0)-th target object detected appearance class that is the target object detected appearance class initially acquired and (2-2) an (i_1)-st target object detected appearance class to an (i_D)-th target object detected appearance class that are the target object detected appearance classes acquired from a first direction to a D-th direction, wherein D is an integer greater than or equal to 1, (iii) generating third feedback information by comparing (1) the target object expected attribute class that is set to be an opposite attribute class of an intended attribute class included in the natural language instructing data with (2) the target object detected attribute class, and (iv) generating fourth feedback information by comparing (1) the expected relationship that is set to be an opposite state of an intended relationship included in the natural language instructing data with (2) the detected relationship.

10. The method of claim 6, wherein the semantic data module (i) generates a depth map corresponding to an entire environment by referring to spatial information of the entire environment from the image, (ii) acquires each object mask corresponding to at least part of all objects included in the entire environment, (iii) back-projects the depth map and said each object mask into a 3D-coordinates to thereby generate a semantic spatial map, and (iv) generates the semantic data by referring to the semantic spatial map.
